(19) United States
(12) Patent Application Publication
(10) Pub. No.: US 2006/0157202 A1
(43) Pub. Date: Jul. 20, 2006

(54) System to bring adhesive backed articles into assembled association with products

(76) Inventor: Giuseppe Jeffrey Arippol, Sao Paulo Sp (BR)

Correspondence Address: STATTLER JOHANSEN & ADELI LLP;ATTN: VINCENT TASSINARI, PO BOX 51860, PALO ALTO, CA, 94303-0728, US

(21) Appl. No.: 10/861,238

(22) Filed: Jun. 4, 2004

(30) Foreign Application Priority Data
Jun. 5, 2003 (BR) PI 0301563-7
Sep. 1, 2003 (BR) CI-0301563

(51) Int. Cl. B32B 37/00; B29C 65/00

(52) U.S. Cl. 156/539

(57) ABSTRACT

The invention may include a system to bring pressure sensitive article in assembled association with a product. The system may include a labeling device, a product moving device, a vacuum box, and a solenoid. The labeling device may have at least one line of labels disposed to move in a first direction. The product moving device may have at least one line of products disposed to move in a second direction, where the first direction is substantially perpendicular to the second direction. The vacuum box may be configured to provide a vacuum in a first mode and an air-blast in a second mode. Moreover, the solenoid may be positioned in the vacuum box and configured to push a label on to a product.

### RELATED APPLICATIONS

This patent claims priority to Brazilian Patent Application No. PI 0301563-7, filed on Jun. 5, 2003, and to Brazilian Patent Application No. C1-0301563, filed on Sep. 1, 2003, each of which is incorporated by reference in this patent.

### BACKGROUND OF THE INVENTION

1. Field of the Invention

The present invention relates to a manufacturing method and apparatus to assemble and join parts, where the apparatus may include means to bring an adhesive backed article into assembled association with a product.

2. Background Information

Adhesive labels, including adhesive tags and other pressure sensitive articles, may be composed of a label adhered to a release liner by an adhesive layer. The release liner, or backing, may be made from paper or silicone plastic tape. The labels may be supplied to user companies in the form of web wound about a reel. When part of a wound web, the labels may be adhered to an elongated liner at regular spaces.

Typically, a label may be applied on a receiver product through a labeling device. Such labeling devices may include a shaft to freely support the web, an unwinder shaft to tug on the liner, and a peel plate having an edge. The web may be folded over the peal plate edge such that the liner follows the surfaces of the peel plate over the edge. As the label web is pulled by the unwinder shaft, the label web passes over the peel plate edge, where the labels may be sequentially separated from the liner.

Products may be brought into a position to receive the recently separated labels. The products to receive the labels may be, for example, regularly spaced printed packages that are part of a continuous product web pulled by conveyor rollers. As a product passes by a recently separated label, the label may be adhered to the product.

To permit the above conventional system to operate properly, the speed of the labels on the labeling device and the speed of the receiver products on a product moving device must be substantially equal. If the product speed is greater than the label speed, then the labels tug at the liner, which harms the set operation. If the product speed is less than the label speed, then each label will bunch up as it adheres to the product such that the label will fold and wrinkle.

Generally, the label's rated speed on a given label device is much slower than the rated speed of the receiver product. In normal operations, a typical label device is operated intermittently, turning the motor on and off, to permit change out of the spent web or to create spaces between label applications. This intermittent operation further diminishes the speed of the labels so that a typical production-line average speed of the labels is about 35% of the rated speed of the labeling device. The significant differences in rated speed between the labeling device and the product moving device cause significant difficulties.

One solution to account for the significant differences in rated speed between the labeling device and the product moving device is to utilize a “vacuum box” (or Jet Box), such as a rotating labeling head comprising an expandable bellows. Here, a strip of adhesive labels is carried on a reel. This strip is passed along a plate at the end of which the label is stripped from its backing and held by vacuum on an expandable bellows. The bellows rotates. When the bellows reaches a position adjacent to a product to be labeled, the vacuum is cut and an air-blast inside the bellows extends the bellows to fix the label on the product. The air-blast is terminated causing the empty bellows to retract. The bellows then is rotated upward to receive another label. With such an operation mode, the speeds of the labeler and that of the system which transports the product are not dependent upon one another and the difficulty of different speeds is settled.

Although the above technique may overcome the differences in device speeds, the relatively slow moving labeling device still reduces the rate at which labels are applied to products. The result is that for ever two label applications, there will be several products between the two successive products receiving labels that do not receive a label. Such a low rate of application of labels on receiver products results in spaces between label applications with a length greater than that which may be desired. A common solution, using as many labelers as may be required to perform an application of labels on all products that pass through a labeling station, is technically complicated and expensive. What is needed is an uncomplicated, cost-effective, and efficient system to bring adhesive backed articles in to assembled association with products.

### BRIEF SUMMARY OF THE INVENTION

The invention may include a system to bring pressure sensitive article in assembled association with a product. The system may include a labeling device, a product moving device, a vacuum box, and a solenoid. The labeling device may have at least one line of labels disposed to move in a first direction. The product moving device may have at least one line of products disposed to move in a second direction, where the first direction is substantially perpendicular to the second direction. The vacuum box may be configured to provide a vacuum in a first mode and an air-blast in a second mode. Moreover, the solenoid may be positioned in the vacuum box and configured to push a label on to a product.

### BRIEF DESCRIPTION OF THE FIGURES

FIG. 1 is a plan view of a labeling system 100;

FIG. 2 is an isometric view of pressure sensitive articles 138 configured in a reel 200 that may be used in labeling system 100;

FIG. 3 is a side view of labeling system 100;

FIG. 4 is a side view of labeling system 100;

FIG. 5 illustrates a method 500 to operate the labeling system 100;

FIG. 6A is a diagram of a labeling sequence 600 carried out with the labeling system 100;

FIG. 6B is a continuation of the diagram in FIG. 6A;

FIG. 7 is an isometric view of a labeling system 700; and

FIG. 8 is an elevated view of an alternative label ejector construction.

### DETAILED DESCRIPTION OF THE EMBODIMENT

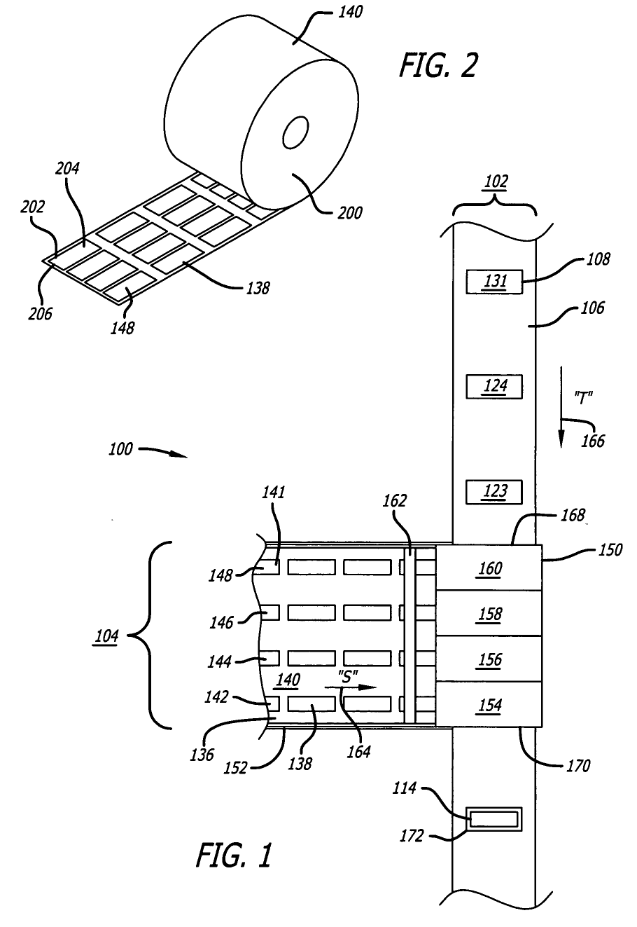

FIG. 1 is a plan view of a labeling system 100. Labeling system 100 may be a system to bring pressure sensitive article in assembled association with a product. Labeling system 100 may include a product moving device 102 and a labeling device 104. Product moving device 102 may include a product conveyor 106 to carry and move products 108, such as product 114, product 123, product 124, and product 131 arranged in a line.

Labeling device 104 may include a label roll 136. Label roll 136 may include articles 138 regularly spaced and positioned along a long strip of release liner 140. Articles 138 may be pressure sensitive articles and may be arranged in label lines 141, such as a label line 142, a label line 144, a label line 146, and a label line 148.

Labeling device 104 further may include labeling heads 150 and an article conveyor 152. As illustrated in FIG. 1, labeling heads 150 may include a labeling head 154, a labeling head 156, a labeling head 158, and a labeling head 160. Article conveyor 152 may include a support bar 162.

Articles 138 may be arranged to move in “S” direction 164 and products 108 may be arranged to move in “T” direction 166. Preferably, “S” direction 164 may be substantially perpendicular to “T” direction 166. In operation, as products 108 moves past assembly entrance 168 and into labeling heads 150, labeling device 104 may apply pressure sensitive articles 138 to products 108, so that as a label and a product travel past assembly exit 170, they do so as an assembled product, such as assembled product 172.

Products 108 may be part of a continuous web that may receive pressure sensitive articles 138 at regular spaces. Products 108 may be moved by product conveyor 106. Product conveyor 106 may be a system of tracking rollers, a conveyor belt system, or a rollers/belt system, each adapted to develop high speeds. Importantly, product conveyor 106 may provide a common support structure onto which products 108 and articles 138 may be assembled.

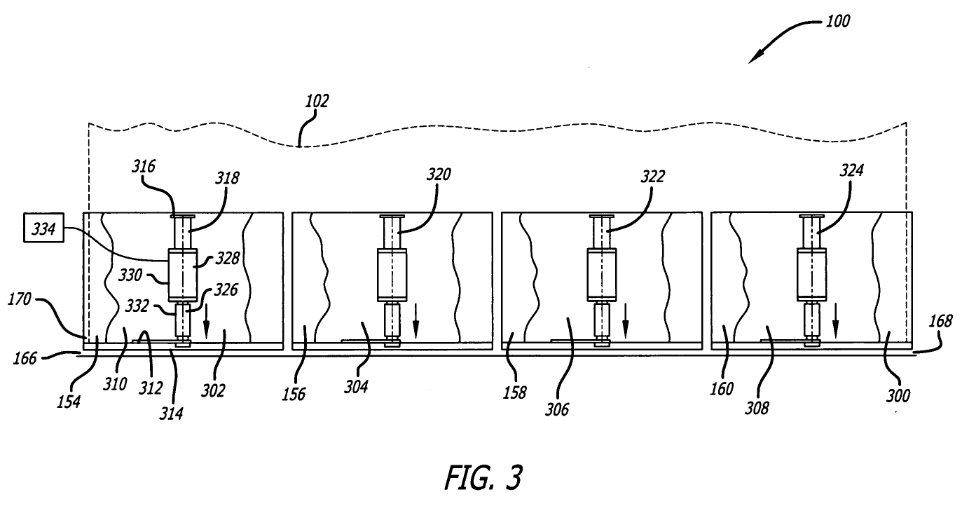

FIG. 2 is an isometric view of pressure sensitive articles 138 configured in a reel 200 that may be used in labeling system 100. As in FIG. 2, pressure sensitive articles 138 may be labels, tags or similar pressure sensitive products that may include a body 202 having a face 204 that may convey information, a pressure sensitive adhesive layer 206 adhered in a back of the body 202. Pressure sensitive articles 138 may remain originally adhered in paper or silicone plastic web (liner), which may operate to provide support and protection, where a plurality of articles 138 may be adhered at regular spaces. Each pressure sensitive article 138, including its body 202 and adhesive layer 206, may be provided on liner 140 in the form of reel 200.

The present labeling device 104 of FIG. 1 may be thought of as a multiple labeler that may include several labeling heads 150, preferably four heads 154, 156, 158, and 160, arranged in displacement direction “S” 164 that may be acute, preferably perpendicular, to the displacement direction “T” 166 of products 108. Products 108 may be thought of as the receivers of the pressure sensitive articles 138. The speed of pressure sensitive articles 138 may be significantly smaller than the speed of products 108.

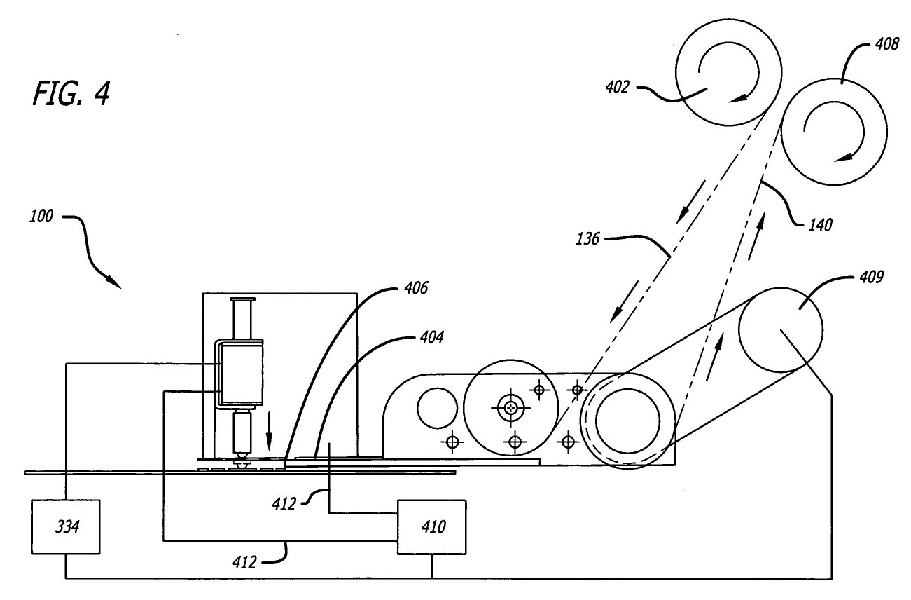

FIG. 3 is a side view of labeling system 100. Each labeling head 154, 156, 158, and 160 may be responsible for dispensing the pressure sensitive articles 138 to be applied in the products 108. “Vacuum boxes” (Jet Boxes) 300 may be provided as part of labeling heads 150 to work towards uncoupling the speed of articles 140 in relation to the speed of products 108 Vacuum boxes 300 may include a vacuum box 302, a vacuum box 304, a vacuum box 306, and a vacuum box 308. Vacuum box 302 may be arranged in adjacent position and a little ahead and above assembly exit 170 and adjacent and above the path “T” 166 of the surfaces of products 108. Each vacuum box 302, 304, 306, and 308 may be adapted to suck and hold a pressure sensitive article 138 promptly after its peeling from liner 140.

Each vacuum box 300 may include a box body 310, a bottom surface 312 that may include sucking bores 314. Sucking bores 314 may be adjacent, ahead and a little above the “S” direction 164 output path of the pressure sensitive articles 138 and above the “T” direction 166 of surfaces of products 108 to receive the pressure sensitive articles 138.

As illustrated in FIG. 3, labeling device 102 further may include ejectors 316. Ejectors 316 may include ejector 318, ejector 320, ejector 322, and ejector 324. Each ejector 318, 320, 322, and 324 may be electromechanical label ejectors which may be located in vacuum boxes 300 in front of label lines 142, 144, 146, and 148 (FIG. 1), respectively. Ejectors 316 may be able to push the pressure sensitive articles 140 against the surface of the receiver products 108.

Each injector 316 may include a pin 326 which may be located as a mobile ejector near bottom surface 312 of each vacuum box 300. Each injector 316 further may include a solenoid 328 and a spring located within the solenoid 328 to displace the pin 326 between two positions: an upper position 330, where the pin 326 does not push, and lower position 332, where the pin 326 may push a pressure sensitive article 138 against the receiver product 108.

Labeling device 102 further may include an electronic set 334. Through, for example, operation logic, electronic set 334 may include devices to increase the labeling rate and may induce the article conveyor 152, product conveyor 106, vacuum boxes 300, and ejectors 316 to operate intermittently and with sequence shots.

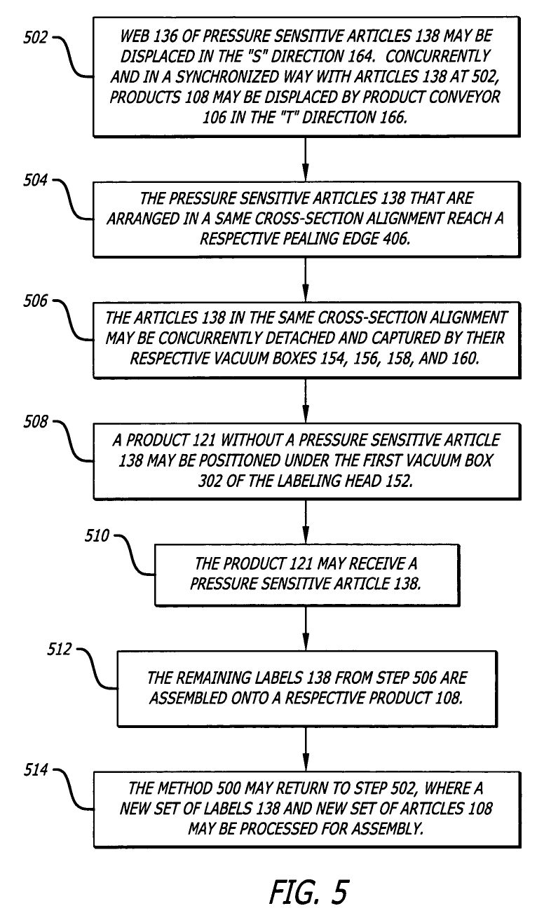

FIG. 4 is a side view of labeling system 100. As in FIG. 4, labeling device 104 further may include a support shaft 402 for a reel 200 of pressure sensitive articles 138 (unwinder) and a peel plate 404 that may include a peeling edge 406. When the label roll 136 is folded over the peeling edge 406, release liner 140 may be superposed on the peel plate 404. The labeling device 104 also may include a liner unwinder 408, that may be driven by its own electric motor 409 to pull the label roll 136, so that as the label roll 136 passes over the peeling edge 406, the pressure sensitive articles 138 may be peeled from release liner 140 in sequence.

Each vacuum box 300 and each ejector 316 may be connected to a vacuum producer pneumatic unit 410. Pneumatics 412 may be connected to each vacuum box 300 and to each ejector 316. Pneumatics 412 may cause each vacuum box 300 to operate in vacuum mode to hold a label article 138 by vacuum and to operate in a pressure mode to apply a label article 138 to a product 108 through an air-blast. Moreover, pneumatics 412 may cause each ejector 316 to apply a label article 138 to a product 108 by pushing on a non-adhesive side of label article 138 (face 204 of FIG. 2, for example). Electronic set 334 may be connected to pneumatic unit 410 and to each ejector 316 to control pneumatics 414 and each ejector 316.

The web or label roll 136 of pressure sensitive articles 138 may work in collaboration with the labeling heads 150. Therefore, the pressure sensitive articles web 138 may have as many label lines 141 of pressure sensitive articles 138 as there are labeling heads 150, for example, four lines 142, 144, 146, and 148 of pressure sensitive articles 138, as illustrated in FIG. 1.

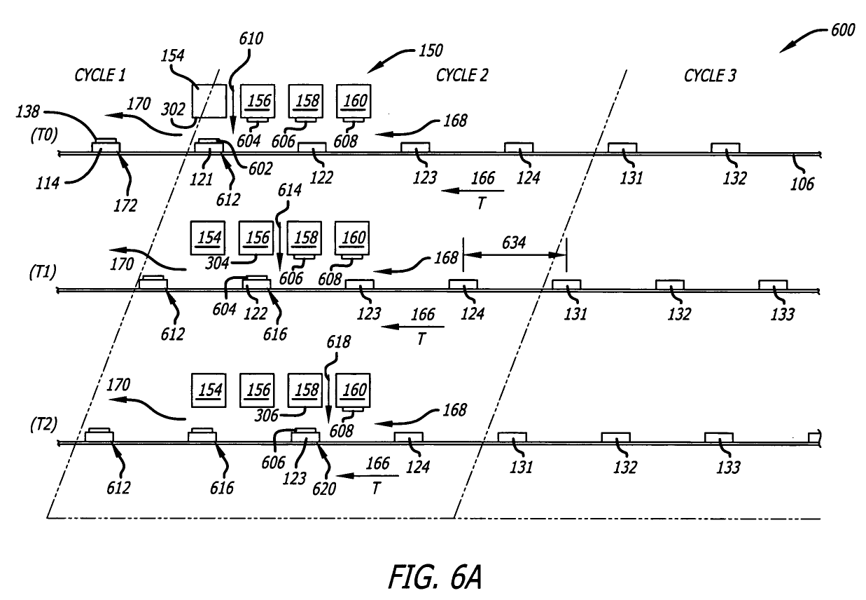

FIG. 5 illustrates a method 500 to operate the labeling system 100. At 502, web 136 of pressure sensitive articles 138 may be displaced in the “S” direction 164. Concurrently and in a synchronized way with articles 138 at 502, products 108 may be displaced by product conveyor 106 in the “T” direction 166. Unlike conventional labeling systems which move labels and products parallel and in a same plane to one another, articles 138 and products 108 may move perpendicular to one another. An advantage here is that a multi-label line web 136 may be employed.

At 504, the pressure sensitive articles 138 that are arranged in a same cross-section alignment reach a respective pealing edge 406. At 506, the articles 138 in the same cross-section alignment may be concurrently detached and captured by their respective vacuum boxes 154, 156, 158, and 160. At 508, a product 121 without a pressure sensitive article 138 may be positioned under the first vacuum box 302 of the labeling head 152. In a sequence of products 108, the product 121 may be located immediately after the last product 114, where the product 114 just received a pressure sensitive article 138 in a prior cycle.

At 510, the product 121 may receive a pressure sensitive article 138. In one embodiment, the article 138 may be pushed by the ejector 318. At 512, the remaining labels 138 from step 506 are assembled onto a respective product 108. Here, in a sequence, the products 122, 123, and 124, each without a pressure sensitive articles 138 may be positioned under the 304, 306, and 308 vacuum boxes, respectively, where each may receive a corresponding pressure sensitive articles 138, thus ending an operation cycle and starting another one.

The device to increase the labeling rate, therefore, may consist in providing the labeling system 100 with an operation cycle defined by four times (FIG. 1) which may repeat successively. At 514, the method 500 may return to step 502, where a new set of labels 138 and new set of articles 108 may be processed for assembly.

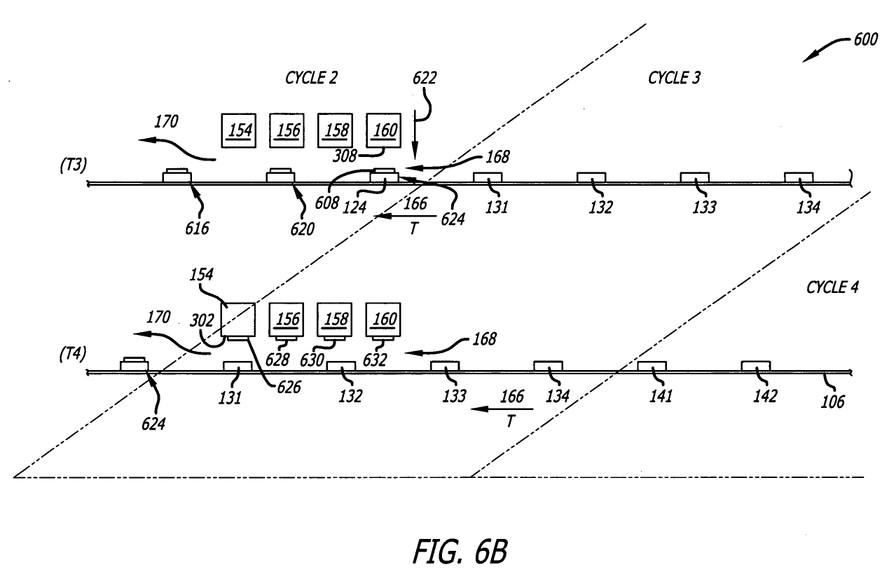

FIG. 6A is a diagram of a labeling sequence 600 carried out with the labeling system 100. Cycle 2 includes products 121, 122, 123, and 124 and cycle 3 includes products 131, 132, 133, and 134. During time 0 (T0), four pressure sensitive articles 602, 604, 606, and 608 of a same cross-section alignment the label roll 136 (FIG. 1) may be located under the labeling heads 154, 156, 158, and 160, respectively. A first product 121 without a pressure sensitive article 138 may be positioned after the last product to receive a pressure sensitive article 138 in the prior cycle (cycle 1), here article 114. Also during time 0, the product 602 may be aligned under the vacuum box 302 of the labeling head 154, which may be located at the end opposite to assembly entrance 168. In such condition, the pressure sensitive article 602 may be transferred at time 0 in the direction of arrow 610 from under the vacuum box 302 to the product 121 located there under, through the ejector 318 (FIG. 3), to create assembled product 612.

During time 1 (T1), the assembled product 612 leaves the position under the first vacuum box 302. Concurrently, a second product 122 may be positioned under the second vacuum box 304 of the second labeling head 156 and the pressure sensitive article 604 positioned in the vacuum box 304 may be moved in the direction of arrow 614 to be transferred to the product 122 through the respective ejector 320 (FIG. 3), thereby creating an assembled product 616.

During time 2 (T2), assembled product 616 leaves the position under the second vacuum box 302. Concurrently, a third product 123 may be positioned under the third vacuum box 306 of the third labeling head 158. The pressure sensitive article 138 positioned in the vacuum box 302 may be transferred in the direction of arrow 618 to the product 123 through the respective ejector 322 (FIG. 3), thereby creating an assembled product 620.

FIG. 6B is a continuation of the diagram in FIG. 6A. During time 3 (T3) illustrated in FIG. 6B, assembled product 620 leaves the position under the third vacuum box 306. Concurrently, a fourth product 124 may be positioned under the fourth vacuum box 308 of the fourth labeling head 160. The pressure sensitive article 608 positioned against the vacuum box 308 may be transferred in the direction of arrow 622 to the product 124 through the respective ejector 324 (FIG. 3), thereby creating an assembled product 624. With a cycle completed, the labeling sequence may prepare to begin a new cycle.

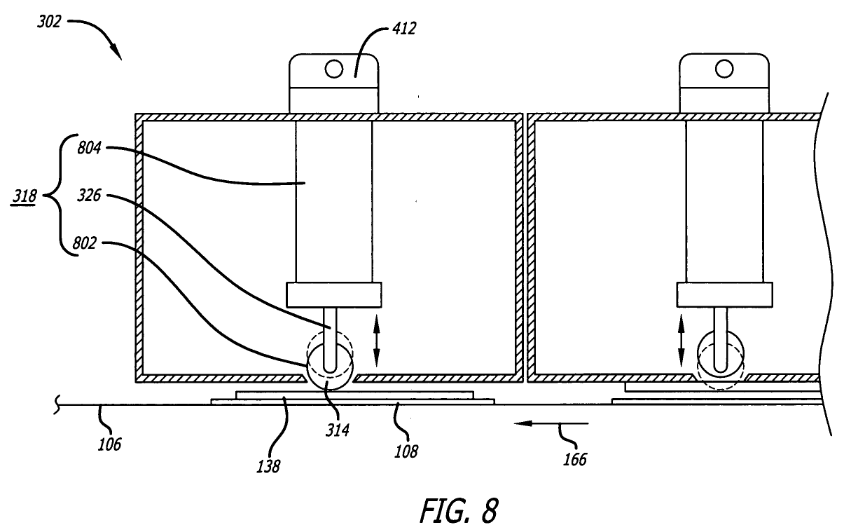

During time 4 (T4), the labeling heads 150 may be reloaded with articles 138 that are aligned transversally in the pressure sensitive products web (label roll) 136. Here, the labeling system 100 may have a longer than adequate time between the triggering of the last label ejector 324 (FIG. 3) and the triggering of the first label ejector 320 (FIG. 3) to reload the labeling heads 150 with articles 138. During this time period and immediately subsequent to the last applied pressure sensitive articles 608, the pressure sensitive articles 626, 628, 630, and 632 may be detached from label roll 136 (FIG. 1), sucked with negative pressure via sucking bores 314 (FIG. 3 and FIG. 8), and then fixed to their respective vacuum boxes 302, 304, 306, and 308. Concurrently, the first product 131 of the new cycle may be positioned under the first vacuum box 302 to receive the article 626. The labeling sequence 600 may return to time 0 (T0), from which a new cycle begins.

An advantage of using vacuum boxes 300 in the negative pressure is that vacuum boxes 300 make the speed of the articles 138 moved by the labeling device 102 independent to that of the products 108 moved by the product moving device 102. Moreover, both the use of more than one ejector 316 and the sequential operation of the multiple ejectors 316 results in a higher label application efficiency in comparison to conventional labeling devices.

Another advantage provided by this labeling system 100 is that the whole set each assembled product may be assembled on the same support structure here product conveyor 106. This works to make easier the installation or relocation before the range of products 108 are to receive the pressure sensitive articles 138.

A further advantage provided by the labeling system 100 is through the use of a label roll 136 having the same number of labeling lines 141 as there are labeling heads 150. Here, the use of a label roll 136 having the same number of labeling lines 141 as there are labeling heads 150 makes easier the replacement of a spent reel of articles 200 (FIG. 2) into the labeling device 104 (FIG. 4).

The basic construction of the labeler may present changes related to materials, dimensions, constructive details and/or configuration, without leaving the scope of the requested protection. Accordingly, labeling device 102 may have any proper quantity of labeling heads 150 and corresponding pressure sensitive article lines 141.

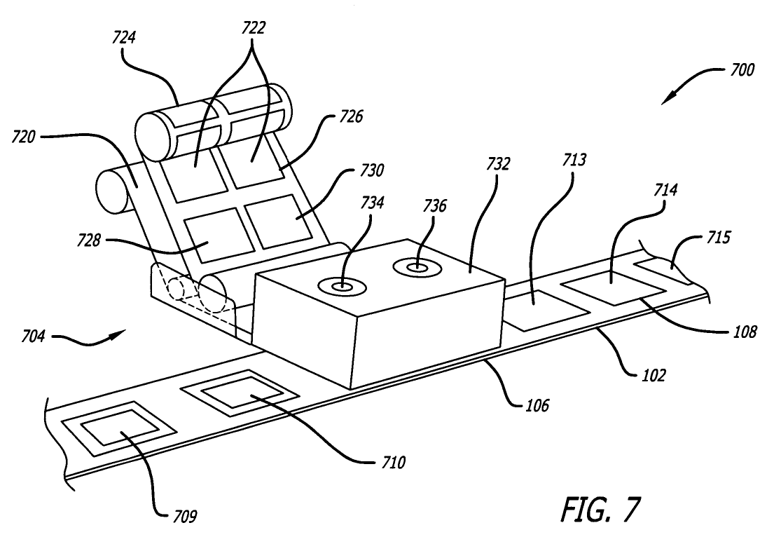

FIG. 7 is an isometric view of a labeling system 700. Labeling system 700 may be a system to bring pressure sensitive article in assembled association with a product. Labeling system 700 may include the product moving device 102 and a labeling device 704. Product moving device 102 may include the product conveyor 106 to carry and move products 108, such as products 709, 710, 711 (hidden), 712 (hidden), 713, 714, and 715 arranged in a line.

Labeling device 704 may include a label roll 720. Label roll 720 may include articles 722 regularly spaced and positioned along a long strip of release liner 724. Articles 722 may be pressure sensitive articles and may be arranged in label lines 726, such as a label line 728 and a label line 730.

Labeling device 704 further may include a labeling head 732 having one ejector for every label line 726. In this embodiment having two label lines 728, 730, one labeling head 732 includes two ejector: ejector 734 and ejector 736.

In the embodiments connected with FIG. 1 through FIG. 7, the pneumatic unit 410 may operate as a vacuum box, which may cause each vacuum box 300 to suck and hold a pressure sensitive article 138, from which the article 138 may be fully peeled from the label web 136 by the labeler 40 in a labeling head 150. The transfer of the pressure sensitive articles 138 to the products 108 may be made by the mechanical action of the ejectors 316. Here, the mechanical action of the ejectors 316 push against an article 138 in opposition to the force of provided by each vacuum boxes 300 until the article 138 meets and is assembled to a receiver surface of the products 108.

Despite such construction of the labeling system 100 of FIG. 1 being efficient, studies continued to improve it. The following embodiments include the results of one of those studies. For example, in the following embodiments, each vacuum box 300 may operate in negative pressure (vacuum), when it sucks and holds the pressure sensitive article 138, and may operate in positive pressure (blow or air-blast), when it blows and collaborates with the ejectors 316 to transfer the pressure sensitive article 138 from the vacuum boxes 300 to the receiver surface of the product 108.

To achieve this, the pneumatic unit 410 of FIG. 4 may be adapted to provide negative pressure (vacuum) to suck and hold the pressure sensitive article 138 promptly after its detaching from the web 136 by a labeling head 150 and adapted to provide positive pressure to blow and push the pressure sensitive articles 138 against the products 108. Each ejector 316 together with the blow provided by a vacuum box 300 in positive pressure may be able to push the pressure sensitive article 138 held in the a vacuum box 300 against the surface of the receiver product 108.

In details, in this embodiment, the labeling heads 150, pneumatic boxes 410, and electromechanical ejectors 316 have constructions similar to those of the embodiments of FIG. 1, with a difference that the pneumatic boxes 300 (FIG. 3) may be connected to a pneumatic unit 410 (FIG. 4), where the pneumatic unit 410 is configured to produce both a negative pressure (vacuum) and a positive pressure to each vacuum box 300. Here, the negative pressure may suck a peeled article 138 to hold the article 138 from a non-adhering surface and the positive pressure may, with or without the assistance of the ejectors 316, air-blast the article 138 from its position against a vacuum box 300 onto a product 108. The electronic set 334 (FIG. 4), responsible for the labeler system 100 operation logic, may have corresponding commands to revert the pneumatic boxes 410 between the negative and positive pressures in proper times of the set operation. Thus, for example, during T0 of FIG. 4A, the pressure sensitive article 602 may be transferred from under the vacuum box 302 to the product 121 through the ejector 318 (FIG. 3) to create assembled product 612. In this embodiment, the pressure sensitive article 602 may be transferred to the product 602 through the mechanical action of ejector 318 and the pneumatic blow provided about the ejector pin 326 by the shifting the vacuum pressure of the vacuum box 302 into a positive, air-blast pressure.

Therefore, this may result in a sequential operation of the ejectors 316 and of the blows provided by the pneumatic boxes 300 in positive pressure, for the transfer of the pressure sensitive articles 138 from the pneumatic boxes 300 to the receiver products 108.

Therefore, pneumatic boxes 300 in negative pressure make independent the speed of the labels 138 in the labeling device 102 in relation to that of the receiver products 108 moved by the rolls/conveyor 106. The multiple ejectors 316 and the blows of the pneumatic boxes 300 in positive pressure, operating sequentially, increase the application frequency, thus resulting in a higher efficiency of this embodiment in relation to other similar devices.

Within the basic construction set forth above, the labeler object of this embodiment may present changes related to materials, dimensions, constructive details and/or configuration, without leaving the scope of the requested protection.

FIG. 8 is an elevated view of an alternative label ejector construction. In this construction option, the label ejector 318 may include a rotating roller 802, the rotation axis of which may be in transversal direction to that of “T” displacement 166 of the product conveyor 106. The rotating roller 802 may be attached to the pin 326. The pin 326 may be positioned partially inside the cylinder 804, whose construction may include a vertical pneumatic cylinder.

The solenoid may be present in the embodiments of FIGS. 1-7 and the embodiments of FIG. 8. In the embodiments of FIG. 8, the air jet may be complementary to the plunger action.

During the use of the embodiments of FIG. 8, it was determined that the best shape of the rotating roller plunger head may be a small wheel. However it also could be a small ball (like a ball bearing or ball point pen).

The labeling system 100 was developed to apply relatively small labels (such as promotional stickers) at high speed, therefore a size range of labels 138 could be between ½×½″ and 2×2″ (but not limited to that). The diameter of plunger 326 preferably may be approximately ⅜″. The material of the plunger 326 may be steel.

The plunger force usually used to overcome the vacuum and apply the label 138 on the product 108 may range from 4 to 6 Bars.

The pneumatic solenoid 328 may be activated by a valve cylinder, such as Festo model ESN-8-25P.

An electrical solenoid 328 may be used, but experiments have shown that it is limited in terms of speed and stroke.

The spacing between label lines 141 (FIG. 1) (which may number more than 4) may be the standard in the label industry (⅛″). The spacing between label applications (element 634 of FIG. 6A) may be directly proportional to the speed of the product line 106 (or the speed of the web 136 in case of packaging film).

The packaging lines 106 may reach 1000 fpm (feet per minute) and a maximum 4000 labels per minute, depending on the spacing 634 between label applications.

Rather than apply labels 138 across the packaging web 136, the above embodiments may apply labels 138 in a sequence along the packaging web 106.

High speed operations may be viewed as over 1000 cycles per minute where as very slow speed may be viewed as 80 cycles/min.

In the above embodiments, the web or objects 106 to be labeled may be running across the label path S 164 versus along the path of conventional labelers. Running the receiving products 106 across the label path S 164 (FIG. 1) permits the use a roll of labels 136 with several labels in the width (in one embodiment 4 labels wide, but not limited to that). Since the roll 136 contains more labels than conventionally used rolls, there is less need to stop to change rolls. Moreover, this construction favors label producers as it is easier to produce the labels as they are normally produced several in the width and then slit. By contrast, very narrow long rolls are unstable, have more footage and therefore are larger diameter rolls than employed in the embodiments. Moreover, wider rolls are easier to handle.

The above system works best for application of labels on packaging film running often at over 1000 fpm. Since the label applicators work perpendicular to the web, the speed of dispensing the label may be independent to the speed of the packaging web, which is different from conventional label applicators that work along the web.

For purposes of explanation, specific embodiments are set forth to provide a thorough understanding of the present invention. However, it will be understood by one skilled in the art from reading this disclosure that the invention may be practiced without these details. Moreover, well-known elements, devices, process steps and the like are not set forth in detail to avoid obscuring the invention.

While the present invention has been particularly described with reference to the various figures, it should be understood that the figures and detailed description, and the identification of certain preferred and alternate materials, are for illustration only and should not be taken as limiting the scope of the invention or excluding still other alternatives. Many changes and modifications may be made to the invention, by one having ordinary skill in the art, without departing from the matter and scope of the invention.

1. A system to bring a pressure sensitive article in assembled association with a product, the system comprising:
a labeling device having at least one line of labels disposed to move in a first direction, where the at least one line of labels includes a first label;
a product moving device having at least one line of products disposed to move in a second direction, where the first direction is substantially perpendicular to the second direction and where the at least one line of products includes a first product;
a vacuum box configured to provide a vacuum in a first mode and an air-blast in a second mode; and
a solenoid positioned in the vacuum box and configured to push the first label onto the first product.

2. The system of claim 1 where the solenoid is a Festo model.

3. The system of claim 1 where the solenoid is a Festo model ESN-8-25P.

4. A system to bring a pressure sensitive article in assembled association with a product, the system comprising:
a labeling device having a plurality of article lines, where a first article line includes a first article;
a product moving device having at least one line of products, where the at least one line of products includes a first product;
a labeling head having a vacuum box configured to provide a vacuum; and
an ejector positioned in the vacuum box and configured to push the first article onto the first product.

5. The system of claim 4, where the plurality article lines are disposed to move in a first direction, where the at one line of products is disposed to move in a second direction, and where the first direction is acute to the second direction.

6. The system of claim 5, where the plurality article lines are disposed to move in a first direction, where the at one line of products is disposed to move in a second direction, and where the first direction is substantially perpendicular to the second direction.

7. The system of claim 4, where the vacuum box further is configured to provide the vacuum in a first mode and an air-blast in a second mode, and where the ejector is configured to push the first article onto the first product in conjunction with an air-blast from the vacuum.

8. The system of claim 4, where the ejector is a plurality of ejectors and where the number of ejectors equals the number of article lines.

9. The system of claim 8, where the number of ejectors equals four and the number of article lines equals four.

10. The system of claim 4, where the vacuum box is a plurality of vacuum boxes and where the number of vacuum boxes equals the number of article lines.

11. The system of claim 4, where the number of vacuum boxes equals one and the number of article lines is at least two.

12. The system of claim 4, where the ejector is configured to push the first article onto the first product on a common support structure.

13. The system of claim 12, where the common support structure is the product moving device.

14. The system of claim 4, where the first article is a pressure sensitive article.

15. The system of claim 4, where the ejector includes a roller.

16. The system of claim 15, where the plurality article lines are disposed to move in a first direction, where the at one line of products is disposed to move in a second direction, where the first direction is acute to the second direction, and where a rotation axis of the roller is position in a transversal direction to the second direction.

17. A method to bring a pressure sensitive article in assembled association with a product, the method comprising:
moving a first article in a first article line with a labeling device having a plurality of article lines;
concurrently and in synchronization with displacing the first article, moving a first product in a line of products with a product moving device;
removing the first article from the first article line with a vacuum provided by a vacuum box; and
pushing the first article onto the first product with an ejector positioned in the vacuum box.

18. The method of claim 17, where pushing the first article onto the first product with the ejector includes pushing the first article onto the first product with the ejector in conjunction with an air-blast from the vacuum box.

19. The method of claim 17, where the first article is moved in a first direction, where the first product is moved in a second direction that is acute to the first direction.

20. The method of claim 19, where pushing the first article onto the first product with the ejector includes pushing the first article onto the first product with a roller attached to the ejector, where a rotation axis of the roller is position in a transversal direction to the second direction.
